(19) United States
(12) Patent Application Publication
(10) Pub. No.: US 2017/0150532 A1
(43) Pub. Date: May 25, 2017

(54) WIRELESS COMMUNICATION SYSTEM, INFORMATION TERMINAL AND COMMUNICATION DEVICE

(71) Applicant: AISIN AW CO., LTD., Anjo-shi, Aichi-ken (JP)

(72) Inventors: Koji YAMASHITA, Anjo (JP); Yosuke NAKANISHI, Okazaki (JP); Kenji ISHIBASHI, Nagoya (JP)

(73) Assignee: AISIN AW CO., LTD., Anjo-shi, Aichi-ken (JP)

(21) Appl. No.: 15/316,717

(22) PCT Filed: Jun. 12, 2015
(86) PCT No.: PCT/JP2015/066983

§ 371 Date: Dec. 6, 2016

(30) Foreign Application Priority Data
Jul. 9, 2014 (JP) 2014-141472

(51) Int. Cl. H04W 76/02

(52) U.S. Cl. CPC H04W 76/02; H04W 4/04

(57) ABSTRACT

A wireless communication system includes an information terminal and a communication device. Communication between the information terminal and the communication device is performed by a first wireless communication through an access point or by a second wireless communication directly between the information terminal and the communication device without passing through the access point. The wireless communication system determines whether the information terminal can be connected to the communication device through the first wireless communication with the information terminal set as the access point. The system transmits an instruction signal for changing the access point to the communication device through the second wireless communication when it is determined that the information terminal cannot be connected to the communication device. The system performs the communication between the information terminal and the communication device through the first wireless communication after the access point has been changed to the communication device.

### TECHNICAL FIELD

Related technical fields include wireless communication systems that perform a communication through a plurality of wireless communication methods, and information terminals and communication devices which configure the wireless communication system.

### BACKGROUND

Up to now, a system in which a plurality of devices communicates with each other by a wireless communication to transmit and receive various pieces of information has been proposed. As the communication method using the wireless communication, there are a method of performing a communication through an access point (base unit, base station, station) such as, for example, Wi-Fi (registered trademark) or the like, and a method of performing a communication directly between the respective devices without passing through an access point such as a Bluetooth (registered trademark) or the like. For example, JP-A-2012-175148 discloses a technique in which two mobile terminals are communicably connected to each other by two types of wireless communication methods of the Wi-Fi and the Bluetooth.

In this case, in the method of performing the communication through the access point such as the Wi-Fi or the like, any device needs to be set as the access point. As the devices settable to the access point, there are information terminals such as a cellular phone, a smartphone, a tablet terminal and so on aside from a dedicated communication device such as a router and so on. In recent years, particularly, since the penetration of the information terminal is high, the router is increasingly replaced with those information terminals.

### SUMMARY

However, some of the above information terminals cannot appropriately operate as the access point. For example, in order to use the information terminal as the access point, a dedicated communication contract with a telecommunications company may be required. In such a case, the information terminal that does not conclude the communication contract cannot appropriately operate as the access point. When the information terminal that cannot appropriately operate as the access point is set as the access point, there is a problem that the information terminal does not operate as the access point, and the communication cannot be performed by the wireless communication.

Exemplary embodiments of the broad inventive principles described herein eliminate the above problems with the conventional art, and an object of exemplary embodiments is to provide a wireless communication system in which even if an information terminal carried by a user is in a state to be inoperable as the access point, the access point is changed from the information terminal to another communication device that performs a communication with the information terminal through another wireless communication method that does not pass through the access point, thereby being capable of performing a communication through the access point between the information terminal and the communication device, and the information terminal and the communication device which configure the wireless communication system.

In order to achieve the above object, a wireless communication system includes an information terminal carried by a user and a communication device that is communicably connected to the information terminal, in which a communication between the information terminal and the communication device is performed by a first wireless communication method that performs the communication through an access point and a second wireless communication method that performs the communication directly between the information terminal and the communication device without passing through the access point. In addition, the wireless communication system is characterized by including connection determination means for determining whether the information terminal can be communicably connected to the communication device through the first wireless communication method in which the information terminal is set as the access point, or not, instruction signal transmission means for transmitting an instruction signal for changing the access point from the information terminal to the communication device through the second wireless communication method when it is determined by the connection determination means that the information terminal cannot be communicably connected to the communication device, and post-change communication means for performing the communication between the information terminal and the communication device through the first wireless communication method after the access point has been changed to the communication device.

Meanwhile, the “access point” is also called a base unit, a base station, or a station.

Also, an information terminal is carried by a user, and communicates with a communication device by a first wireless communication method that performs the communication through an access point and a second wireless communication method that performs the communication directly with the communication device without passing through the access point. In addition, the information terminal is characterized by including connection determination means for determining whether the information terminal can be communicably connected to the communication device through the first wireless communication method in which the information terminal is set as the access point, or not, instruction signal transmission means for transmitting an instruction signal for changing the access point to the communication device, to the communication device through the second wireless communication method when it is determined by the connection determination means that the information terminal cannot be communicably connected to the communication device, and post-change communication means for performing the communication with the communication device through the first wireless communication method after the access point has been changed to the communication device.

Also, a communication device is communicably connected to an information terminal carried by a user, and communicates with the information terminal by a first wireless communication method that performs a communication through an access point and a second wireless communication method that performs the communication directly with the information terminal without passing through the access point. In addition, the communication device is characterized by including instruction signal receiving means for receiving an instruction signal for changing the access point to the communication device from the information terminal through the second wireless communication method when it is determined that the communication device cannot be communicably connected to the information terminal through the first wireless communication method in which the information terminal is set as the access point, connection setting means for setting the communication device to the access point according to the instruction signal when receiving the instruction signal from the information terminal, and post-setting communication means for performing the communication with the information terminal through the first wireless communication method after the communication device has been set to the access point.

According to the wireless communication system having the above configuration, even if the information terminal carried by the user cannot appropriately operate as the access point because of a contract deficiency or the like, the access point is changed from the information terminal to another communication device that performs the communication with the information terminal, thereby being capable of communicating between the information terminal and the communication device through the access point. Therefore, when there is a need to transmit and receive a large amount of data between the devices, the transmission and reception can be completed in a short time by the higher-speed communication method passing through the access point. Since the second wireless communication method does not require the setting of the access point differently from the first wireless communication method, the communication can be established even in a state where the communication cannot be performed through the first wireless communication method, and a process of changing the access point can be approximately executed by performing the communication through the second wireless communication method.

Further, even if the information terminal cannot appropriately operate as the access point because of the contract deficiency or the like, the access point is changed from this terminal to another communication device that performs the communication with this terminal, thereby being capable of communicating with the communication device through the access point. Therefore, when there is a need to transmit and receive a large amount of data with respect to the communication device, the transmission and reception can be completed in a short time by the higher-speed communication method passing through the access point. Since the second wireless communication method does not require the setting of the access point differently from the first wireless communication method, the communication can be established even in a state where the communication cannot be performed through the first wireless communication method, and a process of changing the access point can be approximately executed by performing the communication through the second wireless communication method.

Furthermore, even if the information terminal to be communicated cannot appropriately operate as the access point because of the contract deficiency or the like, the access point is changed from the information terminal to this device, thereby being capable of communicating with the information terminal through the access point. Therefore, when there is a need to transmit and receive a large amount of data with respect to the information terminal, the transmission and reception can be completed in a short time by the higher-speed communication method passing through the access point. Since the second wireless communication method does not require the setting of the access point differently from the first wireless communication method, the communication can be established even in a state where the communication cannot be performed through the first wireless communication method, and a process of changing the access point can be approximately executed by performing the communication through the second wireless communication method.

### BRIEF DESCRIPTION OF DRAWINGS

FIG. 1 is a schematic configuration diagram illustrating a wireless communication system according to the present embodiment.

FIG. 2 is a diagram illustrating a wireless communication method of the wireless communication system according to the present embodiment.

FIG. 3 is a block diagram illustrating a configuration of, particularly, a navigation device of the wireless communication system according to the present embodiment.

FIG. 4 is a block diagram illustrating a configuration of, particularly, an information terminal of the wireless communication system according to the present embodiment.

FIG. 5 is a diagram illustrating a case in which a connection is made through a Wi-Fi with the information terminal as an access point.

FIG. 6 is a diagram illustrating a case in which the connection is made through the Wi-Fi with the navigation device as the access point.

FIG. 7 is a flowchart of a map information update processing program according to the present embodiment.

FIG. 8 is a flowchart of the map information update processing program according to the present embodiment.

### DETAILED DESCRIPTION OF EXEMPLARY EMBODIMENTS

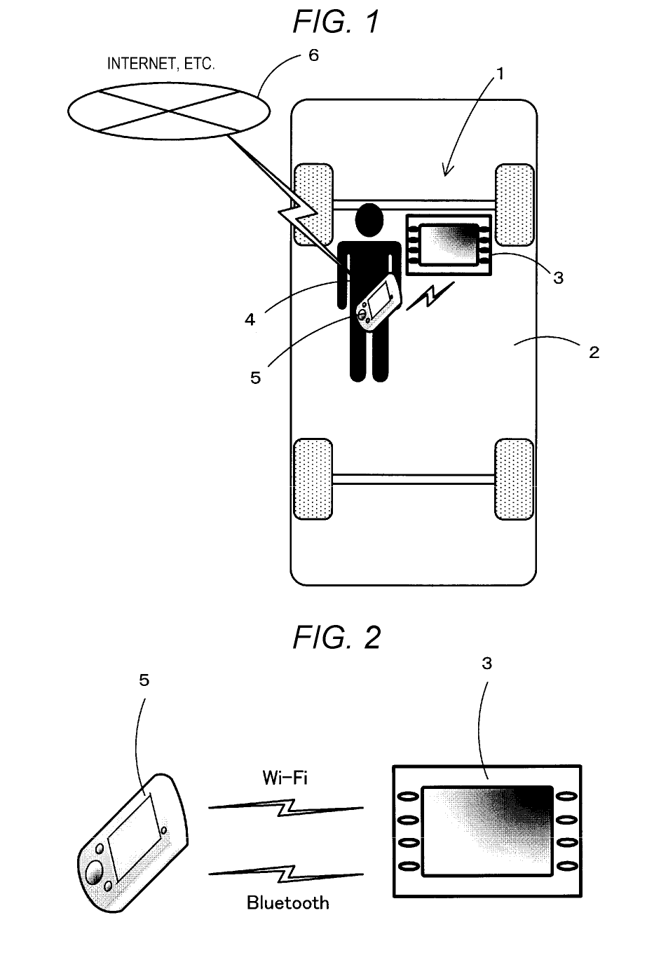

Hereinafter, a wireless communication system, an information terminal, and a communication device will be described with reference to the drawings in detail. First, a schematic configuration of a wireless communication system 1 according to the present embodiment will be described with reference to FIG. 1. FIG. 1 is a schematic configuration diagram illustrating the wireless communication system 1 according to the present embodiment.

As illustrated in FIG. 1, the wireless communication system 1 according to the present embodiment basically includes a navigation device 3 that is a vehicle-mounted device installed in a vehicle 2, and a portable information terminal 5 carried by an occupant (user) 4 of the vehicle 2. The navigation device 3 and the information terminal 5 are configured to be communicably connected to each other by multiple wireless communication methods so as to transmit and receive data with respect to each other. Also, the information terminal 5 is communicably connected to an external server (for example, a center that distributes map update information for updating map information, and so on) through a network communication network 6 such as the Internet or the like.

In this example, in the wireless communication system 1 according to the present embodiment, a communication is performed between the navigation device 3 and the information terminal 5 through two types of wireless communication methods of a Wi-Fi (registered trademark) and a Bluetooth (registered trademark) as shown in FIG. 2. In this example, the Wi-Fi is a wireless communication method which is one of wireless LAN standards, and performs the communication between the devices and a connection to the Internet or the like through a device set to an access point (also called base unit, base station, or station). On the other hand, the Bluetooth (hereinafter referred to as “BT”) is a wireless communication method that performs the communication directly between the devices without passing through the device set to the access point. Meanwhile, the Wi-Fi is broader in a communication bandwidth than the BT (that is, communication speed is higher). On the other hand, since the BT performs pairing by a passkey to perform the communication directly between the devices and is also shorter in a communication range, the BT becomes higher in the security level of the communication than the Wi-Fi. Therefore, data large in size (for example, map update information for updating the map information, or the like) is preferably transmitted and received by the Wi-Fi, and the other data is preferably transmitted and received by the BT at a maximum extent. Meanwhile, in the present embodiment, the Wi-Fi or the BT is used as the wireless communication method, but the Wi-Fi may be replaced with another wireless LAN standard. Also, the BT may be replaced with another short-range wireless communication (for example, infrared communication) without passing through the access point.

Also, in the wireless communication system 1 according to the present embodiment, when the communication using the Wi-Fi is performed, the information terminal 5 is basically set as the access point. In order to operate the information terminal 5 as the access point, a contract with the telecommunications company is required in advance. Therefore, in a situation where such a contract is not performed, and the information terminal 5 and the navigation device 3 cannot be communicably connected to each other with the information terminal 5 as the access point, when data of the large size needs to be transmitted and received, the access point is temporarily changed from the information terminal 5 to the navigation device 3 as will be described later. The details of the change in the access point will be described later.

Also, the navigation device 3 is a vehicle-mounted device that has a function of identifying the current position of a GPS or the like, further displays a map around the subject vehicle position and the current position of the vehicle 2 on the basis of stored map information, and retrieves and guides a route to a set destination.

On the other hand, the information terminal 5 is configured by an information terminal having a navigation function (hereinafter referred to as “NAVI function”) such as a function for identifying the current position (that is, the current position of the user) of the information terminal 5 such as the GPS or the like, a function for displaying a map image around the current position of the user, and so on. For example, a cellular phone, a smartphone, a tablet terminal, a PDA (personal digital assistant), and so on correspond to the information terminal 5. Also, the information terminal 5 according to the present embodiment has a map information updating function for updating the map information stored in the navigation device 3. In this example, the map information updating function is a function of transmitting the map update information downloaded from an external server through the Internet or the like to the navigation device 3 through the communication using the Wi-Fi, and updating the map information in the navigation device 3. Meanwhile, the details of the navigation device 3 and the information terminal 5 will be described later.

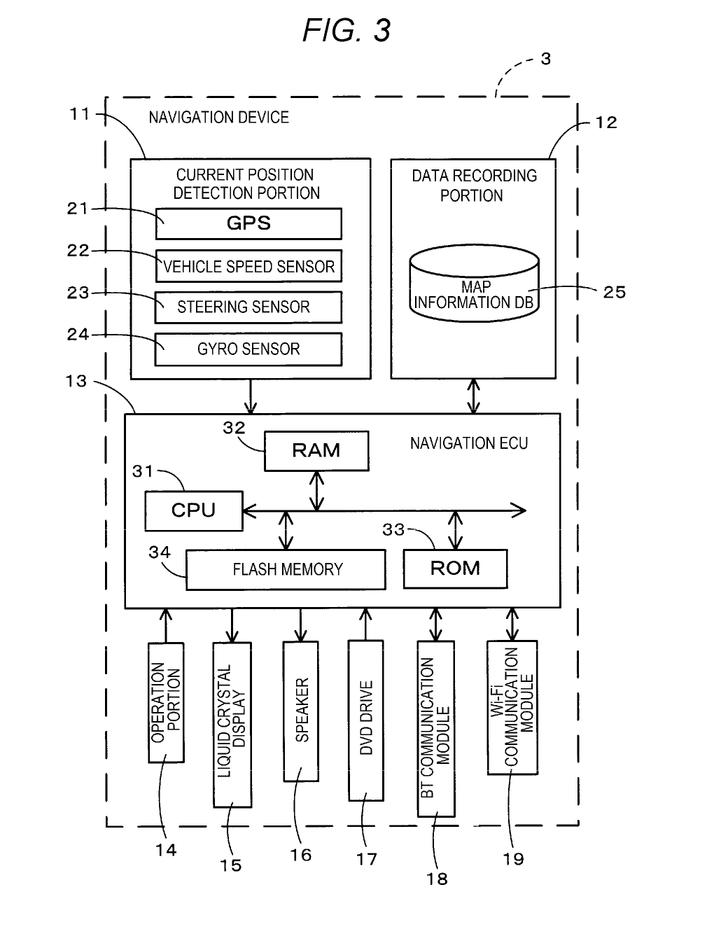

Subsequently, a schematic configuration of the navigation device 3 mounted in the vehicle 2 on which the user 4 gets will be described with reference to FIG. 3. FIG. 3 is a block diagram illustrating the navigation device 3 according to the present embodiment.

As illustrated in FIG. 3, the navigation device 3 according to the present embodiment includes a current position detection portion 11 that detects the current position of the vehicle 2 in which the navigation device 3 is mounted, a data recording portion 12 in which various pieces of data is recorded, a navigation ECU 13 that performs various kinds of arithmetic processing on the basis of input information, an operation portion 14 that is operated by the user, a liquid crystal display 15 that displays a map around the vehicle and facility information on facilities for the user, a speaker 16 that outputs a voice guidance related to a route guide, a DVD drive 17 that reads a DVD which is a storage medium, a BT communication module 18 that performs a wireless communication through the BT, and a Wi-Fi communication module 19 for performing the wireless communication through the Wi-Fi.

Hereinafter, the respective components of the navigation device 3 will be described in order.

The current position detection portion 11 includes a GPS 21, a vehicle speed sensor 22, a steering sensor 23, a gyro sensor 24, and so on, and can detect the current position and the current orientation of the vehicle, a travel speed of the vehicle, a current time, and so on. In this example, particularly, the vehicle speed sensor 22 is a sensor for detecting a moving distance and a vehicle speed of the vehicle, and generates a pulse according to the rotation of driving wheels of the vehicle, and outputs a pulse signal to the navigation ECU 13. Then, the navigation ECU 13 counts the generated pulses to calculate the rotational speed of the driving wheels and the moving distance. Meanwhile, all of the above four types of sensors do not need to be provided in the navigation device 3, and only one or some types of those sensors may be provided in the navigation device 3.

Also, the data recording portion 12 includes an external storage device and a hard disk (not shown) as a recording medium, and a recording head (not shown) that is a driver for reading a map information DB 25, a predetermined program, and the like recorded on the hard disk, and writing predetermined data on the hard disk. Meanwhile, the data recording portion 12 may be configured by a memory card, an optical disc such as a CD or a DVD, or the like instead of the hard disk.

In this example, the map information DB 25 is storage means for storing, for example, link data related to roads (links), node data related to node points, point data related to the points of the facilities or the like, map display data for displaying the map, intersection data related to respective intersections, retrieval data for retrieving a route, search data for searching a point, and so on therein. The map information DB 25 is updated to information on a new version on the basis of the map update information transmitted from the information terminal 5 through the Wi-Fi as will be described later.

Also, the data recording portion 12 records identification information (for example, a BT address, a MAC address, an SSID, and so on) necessary when performing the communication through the Wi-Fi or the BT therein.

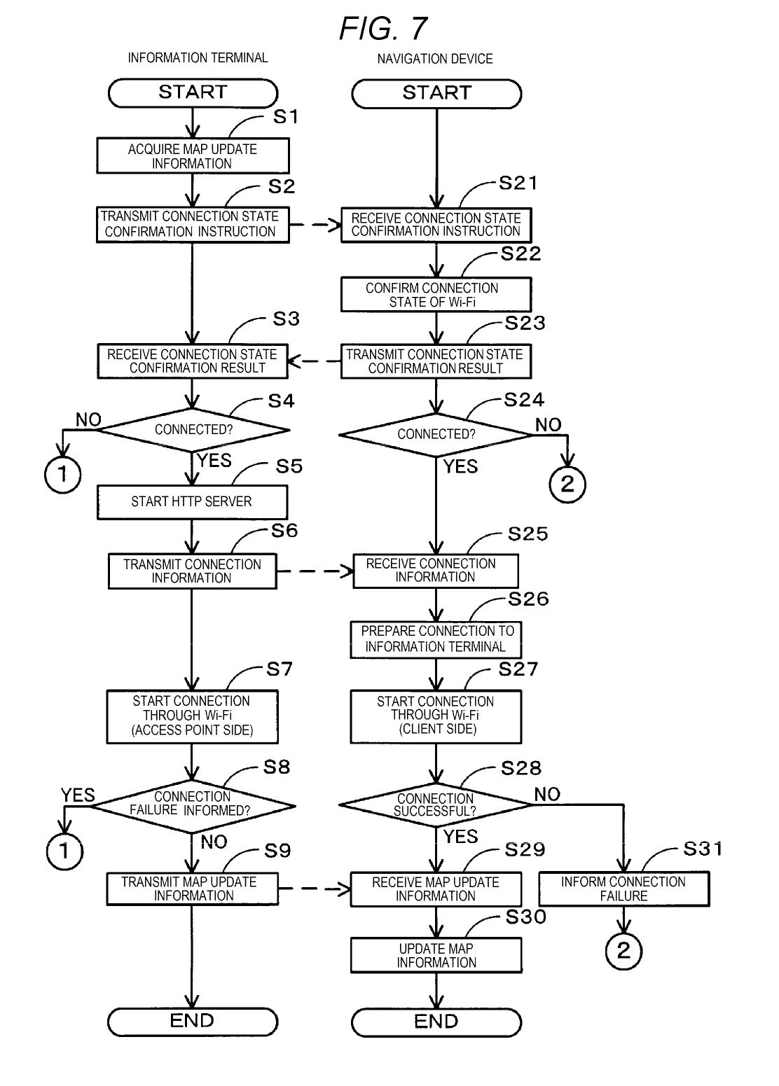

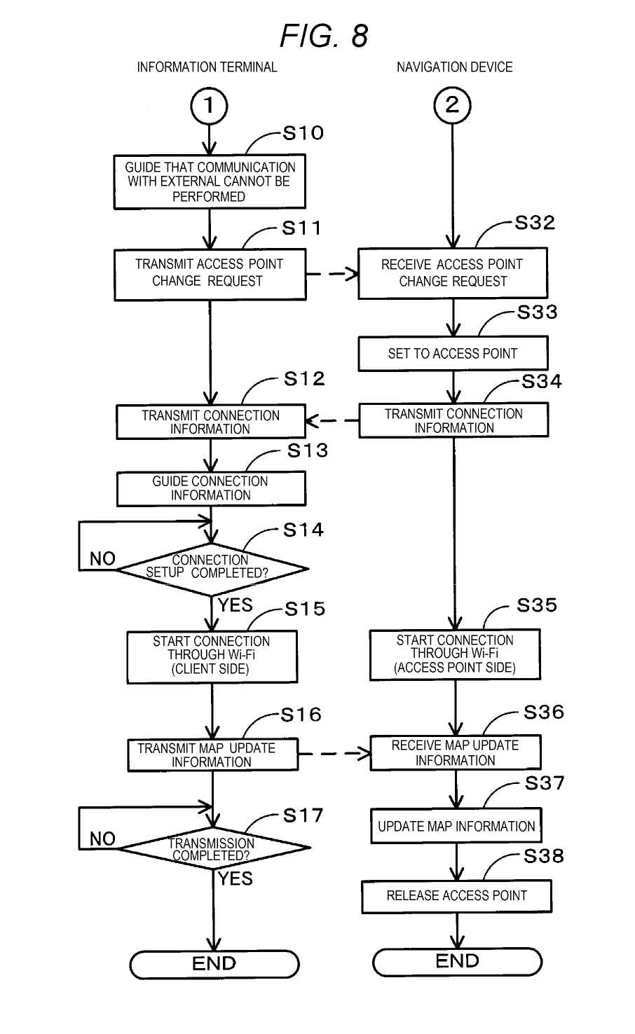

On the other hand, the navigation ECU 13 is an electronic control unit for controlling the overall navigation device 3, and includes a CPU 31 as an arithmetic device and a control device, and internal storage devices such as a RAM 32 that is used as a working memory when the CPU 31 performs various kinds of arithmetic processing and allows the route data when the route is retrieved, and so on to be stored therein, a ROM 33 in which control programs as well as a map information update processing program (refer to FIGS. 7 and 8) to be described later, and so on are recorded, a flash memory 34 that stores the programs read from the ROM 33 therein, and so on. Meanwhile, the navigation ECU 13 configures various means as a processing algorithm along with an ECU of the information terminal 5. For example, instruction signal receiving means receives an instruction signal for changing the access point to the navigation device 3, from the information terminal 5 through the BT when it is determined that the navigation device 3 cannot be communicably connected to the information terminal 5 through the Wi-Fi in which the information terminal 5 is set as the access point. When receiving the instruction signal from the information terminal 5, connection setting means performs the setting of the navigation device 3 to the access point according to the instruction signal. Post-setting communication means performs the communication with the information terminal 5 through the Wi-Fi after the navigation device 3 has been set to the access point.

The operation portion 14 is operated when inputting a departure point as a travel start point and a destination as a travel end point, or the like, and includes multiple operating switches (not shown) such as various types of keys and buttons. The navigation ECU 13 performs the control so as to execute the respective various operations on the basis of switch signals output by depression of the various switches or the like. Meanwhile, the operation portion 14 can be configured by a touch panel disposed on a front surface of the liquid crystal display 15. Also, the operation portion 14 can be configured by a microphone and a speech recognition device.

Also, the map image including the road, traffic information, operation guide, an operation menu, a key guide, a scheduled travel route from the departure point to the destination, guide information along the scheduled travel route, news, a weather forecast, a time, a mail, television programs, and so on are displayed on the liquid crystal display 15. Meanwhile, the liquid crystal display 15 may be replaced with an HUD or an HMD.

Also, the speaker 16 outputs a voice guidance for guiding a travel along the guide route on the basis of an instruction from the navigation ECU 13, and a guide of the traffic information.

Also, the DVD drive 17 is a drive that can read data recorded on a recording medium such as a DVD, a CD, or the like. A reproduction or the like of music or a video is performed on the basis of the read data.

Also, the BT communication module 18 is a module for performing the wireless communication through the BT. The navigation device 3 performs a communication with the information terminal 5 or another device located within a communication range by the wireless communication using the BT through the BT communication module 18.

On the other hand, the Wi-Fi communication module 19 is a module for performing the wireless communication through the Wi-Fi. The navigation device 3 communicates with the information terminal 5 or another device by the wireless communication using the Wi-Fi through the Wi-Fi communication module 19. Meanwhile, the navigation device 3 is configured to be operable as the access point (also called base unit, base station, or station) or operable as a client (also called slave unit) in the Wi-Fi. Meanwhile, in the present embodiment, when the navigation device 3 functions as the access point, the navigation device 3 is not required to be communicably connected to an external server through a network communication network 6 such as the Internet or the like. When the access point is not connected to the external server, only a communication between the devices that are the clients can communicably connected through a device (navigation device 3) set to the access point.

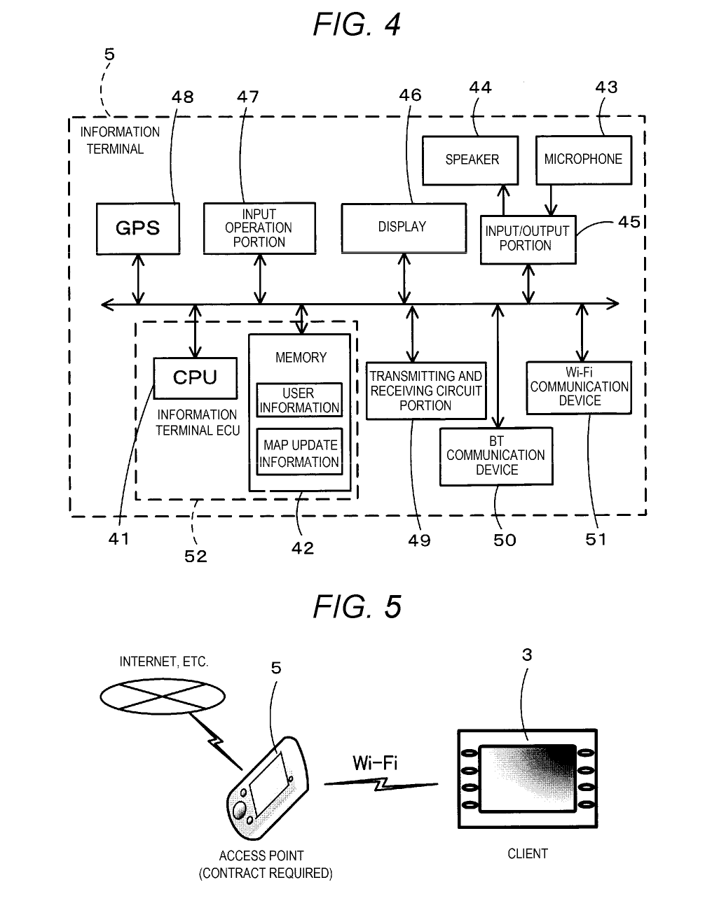

Next, a schematic configuration of the information terminal 5 carried by the user 4 will be described with reference to FIG. 4. FIG. 4 is a block diagram schematically illustrating a control system of the information terminal 5 according to the present embodiment.

As illustrated in FIG. 4, the information terminal 5 is configured so that a data bus is connected with a CPU 41, a memory 42 in which user information (user ID, name, etc.) on the user 4 who carries the information terminal 5, the map update information, and so on are stored, an input/output portion 45 that is an interface such as a microphone 43 and a speaker 44, a display 46 configured by a liquid crystal display panel or the like, an input operation portion 47 configured by a touch panel, a keyboard, or the like, a GPS 48, a transmitting and receiving circuit portion (RF) 49 that transmits and receives a signal with respect to a base station of the network communication network 6, a BT communication device 50 for performing the communication through the BT, and a Wi-Fi communication device 51 for performing the communication through the Wi-Fi.

In this example, the CPU 41 incorporated into the information terminal 5 is control means of the information terminal 5 for executing various operations according the operation program stored in the memory 42, and configures an information terminal ECU 52 along with the memory 42. Also, the various processing contents of the information terminal ECU 52 are displayed on the display 46 as occasion demands. Meanwhile, the information terminal ECU 52 configures various means as a processing algorithm. For example, the connection determination means determines whether the information terminal 5 can be communicably connected to the navigation device 3 through the Wi-Fi in which the information terminal 5 is set to the access point. Instruction signal transmission means transmits an instruction signal for changing the access point to the navigation device 3, to the navigation device 3 through the BT when it is determined by the connection determination means that the information terminal 5 cannot be communicably connected to the navigation device 3. Post-change communication means performs a communication with the navigation device 3 through the Wi-Fi after the access point has been changed to the navigation device 3.

Also, the memory 42 is a storage medium in which a map information update processing program (refer to FIGS. 7 and 8) to be described later, and so on are stored in addition to the user information (user ID, name, etc.) on the user 4 who carries the information terminal 5 and the map update information.

Meanwhile, the map update information stored in the memory 42 is information for updating the map information stored in the navigation device 3, and is acquired from an external server (for example, a center that distributes the map update information for updating the map information) through the transmitting and receiving circuit portion 49. Also, the memory 42 may be configured by a hard disk, a memory card, an optical disc such as a CD or a DVD, or the like. Also, the memory 42 records identification information (for example, a BT address, a MAC address, an SSID, and so on) necessary when performing the communication through the Wi-Fi or the BT therein.

Also, the display 46 is disposed on one surface of a body, and configured by a liquid crystal display, an organic EL display, or the like. Various pieces of information such as input contents by the input operation portion 47, an Internet site, and so on are displayed on the display 46. Also, during the execution of the NAVI function, the map image including the roads, the traffic information, the scheduled traveling route from the departure point to the destination, the guide information along the scheduled traveling route, and so on are displayed on the display 46.

Also, the input operation portion 47 is configured by a touch panel disposed on a front surface of the display 46, hard buttons disposed in the body, or the like. The information terminal ECU 52 performs the control so as to execute the respective various operations on the basis of the electric signals output by depression of the touch panel or hard buttons, or the like. Also, in the present embodiment, in updating the map information stored in the navigation device 3, the input operation portion 47 is operated when performing a connection setup (for example, an input of an SSID and a PASS) for connecting to the Wi-Fi. Meanwhile, the input operation portion 47 can be configured by various types of keys or the like such as number/character input keys, cursor keys for moving a cursor for selecting the displayed contents, a decision key for deciding the selection, and so on.

Also, the GPS 48 receives radio waves generated by an artificial satellite, thereby being capable of detecting the current position and the current time of the information terminal 5 (that is, user 4).

Also, the transmitting and receiving circuit portion 49 is a circuit portion for transmitting and receiving the signal with respect to the base station of the network communication network 6 according to the communication standards such as 3G, 4G, LTE, or the like.

Also, the BT communication device 50 is a module for performing the wireless communication through the BT. The information terminal 5 performs a communication with the navigation device 3 or another device located within a communication range by the wireless communication using the BT through the BT communication device 50.

On the other hand, the Wi-Fi communication device 51 is a module for performing the wireless communication through the Wi-Fi. The information terminal 5 communicates with the navigation device 3 or another device by the wireless communication using the Wi-Fi through the Wi-Fi communication device 51. Meanwhile, the information terminal 5 is configured to be operable as the access point (also called base unit, base station, or station) or operable as a client (also called slave unit) in the Wi-Fi.

In order to operate the information terminal 5 as the access point, a dedicated contract with the telecommunications company is required. With the conclusion of the above communication contract, as illustrated in FIG. 5, the information terminal 5 operates as the access point, and the wireless communication between the information terminal 5 and the navigation device 3 can be performed by the Wi-Fi.

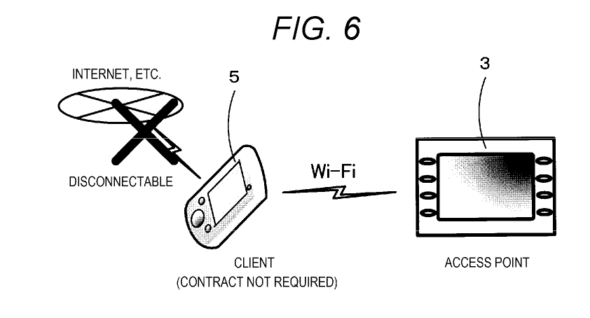

On the other hand, when the communication contract is not concluded, or the information terminal 5 is not originally provided with a function of operating as the access point, the information terminal 5 does not operate as the access point, and the wireless communication between the information terminal 5 and the navigation device 3 through the Wi-Fi cannot be performed. Under the circumstances, if not the information terminal 5 but the navigation device 3 is set to the access point, as illustrated in FIG. 6, the navigation device 3 operates as the access point, and the wireless communication between the information terminal 5 and the navigation device 3 can be performed through the Wi-Fi. However, as described above, the navigation device 3 includes no means for connection to the external network communication network 6 such as the Internet or the like, unlike the information terminal 5. Therefore, when the communication using the Wi-Fi is performed with the navigation device 3 as the access point and the information terminal 5 as the client, the information terminal 5 can communicate with the navigation device 3 through the Wi-Fi, but cannot be connected to the external server. Meanwhile, since the communication between the navigation device 3 and the information terminal 5 through the BT is performed directly between the devices without passing through the access point, the communication can be performed regardless of the presence or absence of the communication contract.

Subsequently, the map information update processing program to be executed in the navigation device 3 and the information terminal 5 configuring the wireless communication system 1 configured as described above will be described with reference to FIGS. 7 and 8. FIGS. 7 and 8 are flowcharts of the map information update processing program according to the present embodiment. In this example, the map information update processing program is a program that is executed when a predetermined operation is performed by the user in the information terminal 5, and updates the map information stored in the navigation device 3. Meanwhile, the following program illustrated as a flowchart in FIGS. 7 and 8 is stored in the RAM, the ROM, or the like provided in the navigation device 3 or the information terminal 5, and executed by the CPU 31 or the CPU 41. Also, a description will be made assuming that the connection between the navigation device 3 and the information terminal 5 through the BT, and the connection between the information terminal 5 and the network communication network 6 have already been established, and the respective components are in a communicable state.

First, the map information update processing program to be executed in the information terminal 5 will be described. In Step (hereinafter referred to as “S”) 1, the CPU 41 of the information terminal 5 acquires the map update information that is information for updating the map information stored in the navigation device 3 from the external server. Meanwhile, the map update information may be newly acquired by the communication at the time of executing the S1, or the map update information acquired from the external server and stored in the memory 42 in advance may be read from the memory 42. Also, the map update information may be information for updating only an appropriate portion of the map information, or may be information for updating (rewriting) the overall map information.

Then, in S2, the CPU 41 transmits a signal (first signal) for instructing to confirm whether the navigation device 3 is in a state of being connected through the Wi-Fi, or not to the navigation device 3 through the BT. Meanwhile, in the subsequent processing, the communication between the information terminal 5 and the navigation device 3 through the BT is often performed. Information necessary to finally transmit the map update information from the information terminal 5 to the navigation device 3 is transmitted through the BT. Also, since a size of the information to be transmitted and received through the BT is very small as compared with the map update information, the transmission and reception can be performed in a short time even through the BT is narrow in the bandwidth. Meanwhile, the navigation device 3 that has received the first signal performs a process of confirming whether the subject device is in a state of being connected through the Wi-Fi, or not, as will be described later (S22).

Then, in S3, the CPU 41 receives a signal (second signal) indicative of a result confirmed by the navigation device 3 according to the first signal transmitted in the S2 from the navigation device 3 through the BT.

Thereafter, in S4, the CPU 41 determines whether the navigation device 3 is in a state of being connected through the Wi-Fi, or not, on the basis of the second signal received in the S3.

Then, if it is determined that the navigation device 3 is in the state of being connected through the Wi-Fi (yes in S4), the program proceeds to S5.

On the contrary, if it is determined that the navigation device 3 is not in the state of being connected through the Wi-Fi (no in S4), it is recognized that an environment in which the communication is performed through the Wi-Fi is not established at the current time, in other words, that the information terminal 5 and the navigation device 3 cannot be communicably connected to each other through the Wi-Fi with the information terminal 5 as the access point. Meanwhile, a reason why the environment in which the communication is performed through the Wi-Fi is not established is that the information terminal 5 is not originally provided with the function of operating as the access point, or even if the information terminal 5 is provided with such a function, the dedicated communication contract for operating the information terminal 5 as the access point is not concluded. Thereafter, the program proceeds to S10.

In S5, the CPU 41 starts the information terminal 5 as an HTTP server. In other words, the CPU 41 starts the operation as the access point of the Wi-Fi.

Then, in S6, the CPU 41 transmits the connection information that is information necessary for connecting to the Wi-Fi in which the information terminal 5 is set as the access point to the navigation device 3 through the BT. Specifically, the CPU 41 transmits information for identifying an IP address and a port of the information terminal 5. Meanwhile, the navigation device 3 that has received the connection information starts the connection to the Wi-Fi in which the information terminal 5 is set as the access point as will be described later (S26, S27).

Subsequently, in S7, the CPU 41 operates the information terminal 5 as the access point, and starts the wireless communication between the information terminal 5 and the navigation device 3 through the Wi-Fi.

Then, in S8, the CPU 41 determines whether a signal informing a failure of the connection has been received from the navigation device 3 through the BT, or not. In this example, as a case in which the navigation device 3 cannot be connected to the information terminal 5 even though the navigation device 3 is in the state of being connected through the Wi-Fi, it is conceivable that the navigation device 3 is in a state of being connected to the Wi-Fi established by the access point (for example, mobile router or public hot spot) other than the information terminal 5.

Then, if it is determined to receive the signal informing the failure of the connection from the navigation device 3 (yes in S8), it is recognized that the information terminal 5 and the navigation device 3 cannot be communicably connected to each other through the Wi-Fi in which the information terminal 5 is set as the access point. The reason why the information terminal 5 and the navigation device 3 cannot be connected to each other is that the information terminal 5 is not originally provided with the function of operating as the access point, or even if the information terminal 5 is provided with such a function, the dedicated communication contract for operating the information terminal 5 as the access point is not concluded. Thereafter, the program proceeds to S10.

On the other hand, if it is determined to receive a signal informing a success of the connection from the navigation device 3 (no in S8), the program proceeds to S9.

In S9, as illustrated in FIG. 5, the CPU 41 operates the information terminal 5 as the access point, to thereby determine that the wireless communication between the information terminal 5 and the navigation device 3 through the Wi-Fi is established, and transmits the map update information acquired in the S1 to the navigation device 3 through the Wi-Fi. Meanwhile, since the Wi-Fi is broader in the bandwidth of the communication (that is, higher in the communication speed) than the BT, even if the size of the map update information is large, the transmission can be completed in a short time. Then, the navigation device 3 that has received the map update information updates the map information stored as described later (S30). Meanwhile, the navigation device 3 may be configured such that the information for identifying a transmission status (for example, what percentage of the entire transmission has been completed) is transmitted from the information terminal 5 to the navigation device 3 through the BT while the map update information being transmitted through the Wi-Fi, and the transmitted information is displayed on the navigation device 3. Thereafter, the navigation device 3 completes the map information update processing program.

On the other hand, in S10, the CPU 41 guides that the external connection to the Internet or the like cannot be temporarily performed in the information terminal 5.

Then, in S11, the CPU 41 transmits a change request signal for changing the access point from the information terminal 5 to the navigation device 3, to the navigation device 3 through the BT. Meanwhile, the navigation device 3 that has received the change request signal performs a process of setting the subject device to the access point of the Wi-Fi as will be described later (S33).

Subsequently, in S12, the CPU 41 receives the connection information transmitted through the BT from the navigation device 3 set to the access point according to the change request signal transmitted in the S11. Meanwhile, the connection information is information necessary for connecting to the Wi-Fi established in a state where the navigation device 3 is set to the access point. Specifically, the connection information is information on the SSID and the PASS.

Then, in S13, the CPU 41 displays the connection information received in the S12 on a display 38 to guide the user the connection information. Then, the user performs the connection setup of the information terminal 5 on the basis of the guided connection information. Specifically, the user inputs the SSID and the PASS to a predetermined communication setting screen. As a result, the information terminal 5 can be connected to the Wi-Fi established in the state where the navigation device 3 is set to the access point.

Then, in S14, the CPU 41 determines whether the connection setup of the information terminal 5 has been completed, or not. If it is determined that the connection setup of the information terminal 5 has been completed (yes in S14), the program proceeds to S15. On the contrary, if it is determined that the connection setup of the information terminal 5 has not been completed (no in S14), the program waits for the completion of the connection setup.

In S15, the CPU 41 operates the information terminal 5 as the client, and starts the wireless communication between the information terminal 5 and the navigation device 3 through the Wi-Fi.

Then, in S16, as illustrated in FIG. 6, the CPU 41 operates the information terminal 5 as the client, to thereby determine that the wireless communication between the information terminal 5 and the navigation device 3 through the Wi-Fi is established, and transmits the map update information acquired in the S1 to the navigation device 3 through the Wi-Fi. Then, the navigation device 3 that has received the map update information updates the map information stored as described later (S37). Meanwhile, the navigation device 3 may be configured such that the information for identifying a transmission status (for example, what percentage of the entire transmission has been completed) is transmitted from the information terminal 5 to the navigation device 3 through the BT while the map update information being transmitted through the Wi-Fi, and the transmitted information is displayed on the navigation device 3. Thereafter, the program proceeds to S17.

Then, in S17, the CPU 41 determines whether the transmission of the map update information has been completed, or not. Then, if it is determined that the transmission of the map update information has been completed (yes in S17), the map information update processing program is completed. On the contrary, if it is determined that the transmission of the map update information has not been completed (no in S17), the program waits for the completion of the transmission.

Next, the map information update processing program to be executed in the navigation device 3 will be described with reference to FIGS. 7 and 8.

First, in S21, the CPU 31 receives the first signal transmitted from the information terminal 5 through the BT. Meanwhile, the first signal is a signal for instructing to confirm whether the navigation device 3 is in the state of being connected through the Wi-Fi, or not, as described above.

Then, in S22, the CPU 31 confirms whether the navigation device 3 is in the state of being connected through the Wi-Fi, or not. Meanwhile, even when it is confirmed that the navigation device 3 is in the state of being connected through the Wi-Fi, the navigation device 3 is not always connected to the Wi-Fi established in a state where the information terminal 5 is set as the access point, and it is conceivable that the navigation device 3 is in the state of being connected to the Wi-Fi established by the access point (for example, mobile router or public hot spot) other than the information terminal 5.

Then, in S23, the CPU 31 transmits a signal (second signal) indicative of a result confirmed by the navigation device 3 in the S22 to the information terminal 5 through the BT. Meanwhile, the information terminal 5 that has received the second signal determines whether the information terminal 5 and the navigation device 3 can be communicably connected to each other through the Wi-Fi in which the information terminal 5 is set to the access point, or not, as described above.

Thereafter, in S24, the CPU 31 determines whether the navigation device 3 is in the state of being connected through the Wi-Fi, or not, as a result confirmed in the S22.

Then, if it is determined that the navigation device 3 is in the state of being connected through the Wi-Fi (yes in S24), the program proceeds to S25. On the contrary, if it is determined that the navigation device 3 is not in the state of being connected through the Wi-Fi (no in S24), the program proceeds to S32.

In S25, the CPU 31 receives the connection information transmitted from the information terminal 5 through the BT. Meanwhile, the connection information is information necessary for connecting to the Wi-Fi in which the information terminal 5 is set to the access point as described above, and specifically, the connection information is information for identifying an IP address and a port of the information terminal 5.

Next, in S26, the CPU 31 performs various settings for connection to the Wi-Fi in which the information terminal 5 is set to the access point on the basis of the connection information received in the S25.

In S27, the CPU 31 operates the navigation device 3 as the client, and starts the wireless communication between the information terminal 5 and the navigation device 3 through the Wi-Fi.

Then, in S28, the CPU 31 determines whether the connection to the IP address of the information terminal 5 through the Wi-Fi can be performed, or not. If it is determined that the connection to the IP address of the information terminal 5 through the Wi-Fi can be performed (yes in S28), the program proceeds to S29. On the contrary, if it is determined that the connection to the IP address of the information terminal 5 through the Wi-Fi cannot be performed (no in S28), the program proceeds to S31.

In S29, the CPU 31 receives the map update information transmitted from the information terminal 5 through the Wi-Fi. Meanwhile, when the CPU 31 receives the information for identifying a transmission status (for example, what percentage of the entire transmission has been completed) from the information terminal 5 through the BT while receiving the map update information through the Wi-Fi, the CPU 31 may be configured to display the current receiving status on the liquid crystal display 15.

Thereafter, in S30, the CPU 31 updates the map information stored in the data recording portion 12 according to the map update information received from the information terminal 5 in the S29. Then, the CPU 31 completes the map information update processing program after the update of the map information has been completed.

On the other hand, in S31, the CPU 31 transmits a signal informing that the connection to the information terminal 5 through the Wi-Fi could not be performed to the information terminal 5 through the BT. Thereafter, the program proceeds to S32.

In S32, the CPU 31 receives the change request signal transmitted from the information terminal 5 through the BT. Meanwhile, the change request signal is a signal for instructing to change the access point from the information terminal 5 to the navigation device 3.

Then, in S33, the CPU 31 performs a process of setting the navigation device 3 to the access point of the Wi-Fi. Specifically, the CPU 31 performs a process of switching the operation mode of the navigation device 3 from the client to the access point.

Then, in S34, the CPU 31 transmits the connection information necessary for connecting to the Wi-Fi established in the state where the navigation device 3 is set to the access point to the information terminal 5 through the BT. Specifically, the connection information is information on the SSID and the PASS. Meanwhile, the information terminal 5 that has received the connection information guides the user the connection information in the information terminal 5 as described above (S13), and performs the connection setup in the information terminal 5.

In S35, the CPU 31 operates the navigation device 3 as the access point, and starts the wireless communication between the information terminal 5 and the navigation device 3 through the Wi-Fi.

Thereafter, in S36, the CPU 31 receives the map update information transmitted from the information terminal 5 through the Wi-Fi. Meanwhile, when the CPU 31 receives the information for identifying a transmission status (for example, what percentage of the entire transmission has been completed) from the information terminal 5 through the BT while receiving the map update information through the Wi-Fi, the CPU 31 may be configured to display the current receiving status on the liquid crystal display 15.

Thereafter, in S37, the CPU 31 updates the map information stored in the data recording portion 12 according to the map update information received from the information terminal 5 in the S36. Then, the program proceeds to S38 after the update of the map information has been completed.

In S38, the CPU 31 performs a process of releasing the navigation device 3 from the access point of the Wi-Fi (returns to the client). Specifically, the CPU 31 performs a process of switching the operation mode of the navigation device 3 from the access point to the client. Meanwhile, even before the update of the map information is completed, if the transmission and reception of the map update information has been completed, the CPU 31 may execute the processing of the S38. As a result, the Wi-Fi established in the state where the navigation device 3 is set to the access point is released, and the connection to the external such as the Internet or the like which has been interrupted in the information terminal 5 can be performed. Thereafter, the navigation device 3 completes the map information update processing program.

As described above, the wireless communication system 1 according to the present embodiment includes the information terminal 5 carried by the user and the navigation device 3 that is communicably connected to the information terminal 5, in which the communication between the information terminal 5 and the navigation device 3 is performed by the Wi-Fi that performs the communication through the access point and the BT that performs the communication directly between the information terminal 5 and the navigation device 3 without passing through the access point. It is determined whether the information terminal 5 and the navigation device 3 can be communicably connected to each other through the Wi-Fi in which the information terminal 5 is set as the access point, or not (S4, S8). If it is determined that the information terminal 5 and the navigation device 3 cannot be communicably connected to each other, the instruction signal for changing the access point from the information terminal 5 to the navigation device 3 is transmitted through the BT (S11). After the access point has been changed to the navigation device 3, the communication is performed between the information terminal 5 and the navigation device 3 through the Wi-Fi (S16, S36). As a result, even in a state where the information terminal 5 carried by the user cannot appropriately operate as the access point because of a contract deficiency or the like, the access point is changed from the information terminal 5 to the navigation device 3, thereby being capable of performing the communication between the information terminal 5 and the navigation device 3 through the access point. Therefore, when there is a need to transmit and receive a large amount of data such as the map update information between the devices, the transmission and reception can be completed in a short time by the higher-speed communication method passing through the access point.

Since the wireless communication method using the BT does not require the setting of the access point differently from the Wi-Fi, the communication can be established even in a state where the communication cannot be performed through the Wi-Fi, and a process of changing the access point can be approximately executed by performing the communication through the BT.

Meanwhile, the above embodiment should not be considered limiting. It can be variously improved and modified without departing from the spirit of the inventive principles.

For example, in the present embodiment, the processing of S1 to S18 in the map information update processing program (FIGS. 7 and 8) is executed by the information terminal 5, and the processing of S21 to S37 in the map information update processing program (FIGS. 7 and 8) is executed by the navigation device 3. However, the subjects that execute the respective steps can be appropriately changed between the information terminal 5 and the navigation device 3. For example, the determination of whether the information terminal 5 and the navigation device 3 can be communicably connected to each other through the Wi-Fi in which the information terminal 5 is set to the access point, or not, may be configured by not the information terminal 5 but the navigation device 3.

Also, in the present embodiment, when the map information stored in the navigation device 3 is updated, in other words, when there is a need to transmit the map update information large in the data size from the information terminal 5 to the navigation device 3, the processing for confirming the communication state in S2 and subsequent steps and changing the access point is executed. However, when there is a need to transmit the data of a predetermined size or more from the information terminal 5 to the navigation device 3, or from the navigation device 3 to the information terminal 5 without being limited to the update time of the map information, the processing of S2 and the subsequent steps may be executed. Meanwhile, it is assumed that the “predetermined size or more” represents a size higher in the processing efficiency when transmitting through the Wi-Fi than the BT. For example, when the backup of the data in the navigation device 3 is transmitted to the information terminal 5, or the like, the processing in S2 and the subsequent steps is executed.

Also, in the present embodiment, the navigation device 3 is exemplified as the communication device communicably connected to the information terminal 5. However, any device communicably connected to the information terminal 5 aside from the navigation device 3 can be used. For example, a vehicle-mounted audio device, a personal computer, a tablet terminal or the like may be applicable.

Also, in the present embodiment, the navigation device 3 has no connection means to the network communication network 6, but may have the connection means to the network communication network 6. In that case, as illustrated in FIG. 6, even if the communication is performed through the Wi-Fi with the navigation device 3 as the access point and the information terminal 5 as the client, the information terminal 5 can continuously perform the connection to the external server through the navigation device 3.

Also, the wireless communication system according to the embodiment has been described above. However, an information management system can have the following configuration, and in that case, obtains the following advantages.

For example, the first configuration will be described below.

A wireless communication system including an information terminal carried by a user and a communication device that is communicably connected to the information terminal in which a communication between the information terminal and the communication device is performed by a first wireless communication method that performs the communication through an access point and a second wireless communication method that performs the communication directly between the information terminal and the communication device without passing through the access point, includes connection determination means for determining whether the information terminal can be communicably connected to the communication device through the first wireless communication method in which the information terminal is set as the access point, or not; instruction signal transmission means for transmitting an instruction signal for changing the access point from the information terminal to the communication device through the second wireless communication method when it is determined by the connection determination means that the information terminal cannot be communicably connected to the communication device; and post-change communication means for performing the communication between the information terminal and the communication device through the first wireless communication method after the access point has been changed to the communication device.

According to the wireless communication system having the above configuration, even if the information terminal carried by the user cannot appropriately operate as the access point because of a contract deficiency or the like, the access point is changed from the information terminal to another communication device that performs the communication with the information terminal, thereby being capable of communicating between the information terminal and the communication device through the access point. Therefore, when there is a need to transmit and receive a large amount of data between the devices, the transmission and reception can be completed in a short time by the higher-speed communication method passing through the access point. Since the second wireless communication method does not require the setting of the access point differently from the first wireless communication method, the communication can be established even in a state where the communication cannot be performed through the first wireless communication method, and a process of changing the access point can be approximately executed by performing the communication through the second wireless communication method.

For example, the second configuration will be described below.

The communication device is a vehicle-mounted device mounted on a vehicle, and the information terminal is an information terminal carried by a user who is an occupant of the vehicle.

According to the wireless communication system having the above configuration, even in a case where the information terminal carried by the user who is an occupant of the vehicle cannot appropriately operate as the access point because of a contract deficiency or the like, the access point is changed from the information terminal to a vehicle-mounted device, thereby being capable of communicating between the information terminal and the vehicle-mounted device through the access point. Therefore, when there is a need to transmit and receive a large amount of data such as the map update information between the devices in a state where the user gets on the vehicle, the transmission and reception can be completed in a short time by the higher-speed communication method passing through the access point.

For example, the third configuration will be described below.

The first wireless communication method is broader in a bandwidth of the communication than the second wireless communication method.

According to the wireless communication system having the above configuration, when there is a need to transmit and receive a large amount of data between the devices, the transmission and reception can be completed in a short time by the first wireless communication method higher in speed than the second wireless communication method.

The fourth configuration will be described below.

The second wireless communication method is higher in a security level of the communication than the first wireless communication method.

According to the wireless communication system configured as described above, information required for preventing the leakage to the outside, such as the information related to the connection setup, the identification information on the device, or the like is communicated through the second wireless communication method, thereby being capable of realizing the high security. Therefore, a reduction in the security can be prevented while the communication speed is improved.

The fifth configuration will be described below.

The connection determination means transmits a first signal for confirming whether the information terminal and the communication device are in a state of being connected to each other through the first wireless communication method, or not, from the information terminal to the communication device through the second wireless communication method, transmits a result confirmed by the communication device according to the first signal as a second signal from the communication device to the information terminal through the second wireless communication method, and determines whether the information terminal and the communication device can be communicably connected to each other through the first wireless communication method in which the information terminal is set as the access point, or not.

According to the wireless communication system configured as described above, the communication is performed between the devices through the second wireless communication method without passing through the access point, thereby being capable of precisely determining whether the information terminal and the communication device can be communicably connected to each other through the first wireless communication method in which the information terminal is set as the access point, or not.

The sixth configuration will be described below.

The connection determination means determines that the information terminal and the communication device cannot be communicably connected to each other through the first wireless communication method in which the information terminal is set as the access point when the result confirmed by the communication device according to the first signal is not the state of being connected through the first wireless communication method, or the connection to an IP address of the information terminal cannot be performed even if the information terminal and the communication device are in the state of being connected through the first wireless communication method.

According to the wireless communication system configured as described above, taking the case in which the communication device is in the state of being connected to the Wi-Fi established by the access point (for example, mobile router or public hot spot) other than the information terminal into account, it can be precisely determined whether the information terminal and the communication device can be communicably connected to each other through the first wireless communication method in which the information terminal is set as the access point, or not.

The seventh configuration will be described below.

The wireless communication system includes connection information transmission means for transmitting connection information for connecting the information terminal to the communication device through the first wireless communication method after the access point is changed to the communication device from the communication device to the information terminal through the second wireless communication method; and connection information guide means for guiding the connection information in the information terminal that receives the connection information.

According to the wireless communication system configured as described above, the information necessary for connection through the first wireless communication method can be guided the user through the information terminal by the second wireless communication method without using the first wireless communication method.

The eighth configuration will be described below.

The connection determination means determines whether the information terminal and the communication device can be communicably connected to each other through the first wireless communication method in which the information terminal is set as the access point, or not, when transmitting information of a predetermined size or more from the information terminal to the communication device or from the communication device to the information terminal, and the post-change communication means transmits and receives the information of the predetermined size or more between the information terminal and the communication device through the first wireless communication method.

According to the wireless communication system having the above configuration, when there is a need to transmit and receive data of a predetermined size or more between the devices, the transmission and reception can be completed in a short time by the higher-speed communication method passing through the access point.

The ninth configuration will be described below.

Information necessary to transmit the information of the predetermined size or more through the first wireless communication method is transmitted and received between the information terminal and the communication device through the second wireless communication method.

According to the wireless communication system configured as described above, the information not large in the size is communicated through the second wireless communication method at a maximum extent, thereby being capable of preventing the security from being reduced. Since the second wireless communication method does not require the setting of the access point differently from the first wireless communication method, the communication can be established even in a state where the communication cannot be performed through the first wireless communication method, and a variety of processes necessary to transmit and receive the information can be executed by performing the communication through the second wireless communication method.

The tenth configuration will be described below.

The amount of information transmitted and received through the first wireless communication method is larger than the amount of information transmitted and received through the second wireless communication method.

According to the wireless communication system configured as described above, the information small in the size such as the information related to the connection setup, the identification information on the device, or the like is communicated through the second wireless communication method, thereby being capable of realizing the high security. Therefore, a reduction in the security can be prevented while the communication speed is improved.

The eleventh configuration will be described below.

The wireless communication system further includes releasing means for releasing the communication terminal from the access point after the transmission of the information of the predetermined size or more through the first wireless communication method has been completed.

According to the wireless communication system configured as described above, after the transmission of the information has been completed, the setup of the access point is returned to the original, as a result of which a trouble caused in the subsequent communication (for example, the information terminal cannot be connected to the Internet, or the like) can be eliminated.

The twelfth configuration will be described below.

The connection determination means determines whether the information terminal and the communication device can be communicably connected to each other through the first wireless communication method in which the information terminal is set as the access point, or not, when updating map information stored in the communication device, and the information of the predetermined size or more is update information for updating the map information.

According to the wireless communication system having the above configuration, particularly, when there is a need to transmit and receive data for updating the map information large in the data size, the transmission and reception can be completed in a short time by the higher-speed communication method passing through the access point.

The thirteenth configuration will be described below.

In a state where the access point is changed to the communication device, and the information terminal and the communication device are communicably connected to each other through the first wireless communication method, the information terminal cannot be connected to an external server through the first wireless communication method.

According to the wireless communication system configured as described above, the connection between the devices through the first wireless communication method is temporarily prioritized over the connection to the external server, thereby being capable of realizing the higher-speed communication method, and capable of appropriately transmitting and receiving the large amount of data.

1. A wireless communication system including an information terminal carried by a user and a communication device that is communicably connected to the information terminal, and in which a communication between the information terminal and the communication device is performed by a first wireless communication that performs the communication through an access point and a second wireless communication that performs the communication directly between the information terminal and the communication device without passing through the access point, the wireless communication system comprising:
a processor programmed to:
determine whether the information terminal can be communicably connected to the communication device through the first wireless communication in which the information terminal is set as the access point;
transmit an instruction signal for changing the access point from the information terminal to the communication device through the second wireless communication when it is determined that the information terminal cannot be communicably connected to the communication device; and
perform the communication between the information terminal and the communication device through the first wireless communication after the access point has been changed to the communication device.

2. The wireless communication system according to claim 1, wherein:
the communication device is a vehicle-mounted device mounted on a vehicle, and the information terminal is an information terminal carried by a user who is an occupant of the vehicle.

3. The wireless communication system according to claim 1, wherein:
the first wireless communication is broader in a bandwidth of the communication than the second wireless communication.

4. The wireless communication system according to claim 1, wherein:
the second wireless communication is higher in a security level of the communication than the first wireless communication.

5. The wireless communication system according claim 1, wherein the processor is programmed to:
transmit a first signal for confirming whether the information terminal and the communication device are in a state of being connected to each other through the first wireless communication, from the information terminal to the communication device through the second wireless communication;
receive a result confirmed by the communication device according to the first signal as a second signal from the communication device to the information terminal through the second wireless communication; and
determine whether the information terminal and the communication device can be communicably connected to each other through the first wireless communication in which the information terminal is set as the access point.

6. The wireless communication system according to claim 1, wherein the processor is programmed to:
determine that the information terminal and the communication device cannot be communicably connected to each other through the first wireless communication in which the information terminal is set as the access point when the result confirmed by the communication device according to the first signal is not the state of being connected through the first wireless communication, or an IP address of the information terminal is not connectable even if the information terminal and the communication device are in the state of being connected through the first wireless communication.

7. The wireless communication system according to claim 1, wherein the processor is programmed to:
receive connection information for connecting the information terminal to the communication device through the first wireless communication after the access point is changed to the communication device from the communication device to the information terminal through the second wireless communication; and
guide the connection information used to guide the connection information in the information terminal that receives the connection information.

8. The wireless communication system according to claim 1, wherein the processor is programmed to:
determine whether the information terminal and the communication device can be communicably connected to each other through the first wireless communication in which the information terminal is set as the access point, when transmitting information of a predetermined size or more from the information terminal to the communication device or from the communication device to the information terminal; and
transmit and receive the information of the predetermined size or more between the information terminal and the communication device through the first wireless communication.

9. The wireless communication system according to claim 8, wherein:
information necessary to transmit the information of the predetermined size or more through the first wireless communication is transmitted and received between the information terminal and the communication device through the second wireless communication.

10. The wireless communication system according to claim 9, wherein:
the amount of information transmitted and received through the first wireless communication is larger than the amount of information transmitted and received through the second wireless communication.

11. The wireless communication system according to claim 8, wherein the communication device is released from the access point after the transmission of the information of the predetermined size or more through the first wireless communication has been completed.

12. The wireless communication system according to claim 8, wherein:
the processor is programmed to determine whether the information terminal and the communication device can be communicably connected to each other through the first wireless communication in which the information terminal is set as the access point, when updating map information stored in the communication device; and
the information of the predetermined size or more is update information for updating the map information.

13. The wireless communication system according to claim 1, wherein:
in a state where the access point is changed to the communication device, and the information terminal and the communication device are communicably connected to each other through the first wireless communication, the information terminal cannot be connected to an external server through the first wireless communication.

14. An information terminal that is carried by a user, and performs a communication with a communication device by a first wireless communication for performing the communication through an access point and a second wireless communication for performing the communication directly with the communication device without passing through the access point, the information terminal comprising:
a processor programmed to:
determine whether the information terminal can be communicably connected to the communication device through the first wireless communication in which the information terminal is set as the access point;
transmit an instruction signal for changing the access point to the communication device, to the communication device through the second wireless communication when it is determined that the information terminal cannot be communicably connected to the communication device; and
perform the communication with the communication device through the first wireless communication after the access point has been changed to the communication device.

15. A communication device that is communicably connected to an information terminal carried by a user, and performs a communication with the information terminal by a first wireless communication that performs the communication through an access point and a second wireless communication that performs the communication directly with the information terminal without passing through the access point, the communication device comprising:
a processor programmed to:
receive an instruction signal for changing the access point to the communication device, from the information terminal through the second wireless communication when it is determined that the communication device cannot be communicably connected to the information terminal through the first wireless communication in which the information terminal is set as the access point;
set the communication device to the access point according to the instruction signal when receiving the instruction signal from the information terminal; and
perform the communication with the information terminal through the first wireless communication after the communication device has been set to the access point.
